(19) United States
(12) Patent Application Publication
(10) Pub. No.: US 2019/0283255 A1
(43) Pub. Date: Sep. 19, 2019

(54) ROBOT COOPERATION METHOD AND DEVICE, ROBOT, ROBOT SYSTEM, AND COMPUTER PROGRAM PRODUCT

(71) Applicant: CLOUDMINDS (SHENZHEN) ROBOTICS SYSTEMS CO., LTD., Shenzhen (CN)

(72) Inventor: Yonghui WANG, Shenzhen (CN)

(73) Assignee: CLOUDMINDS (SHENZHEN) ROBOTICS SYSTEMS CO., LTD., Shenzhen (CN)

(21) Appl. No.: 16/428,995

(22) Filed: Jun. 1, 2019

Related U.S. Application Data
(63) Continuation of application No. PCT/CN2016/113249, filed on Dec. 29, 2016.

(51) Int. Cl. B25J 9/16

(52) U.S. Cl. CPC B25J 9/1682; B25J 9/1669; B25J 9/163

(57) ABSTRACT

A robot cooperation method includes: acquiring a team task, determining each robot in a robot team; determining a leader robot for the robot team; and determining whether any one robot in the robot team is the leader robot. If so, the any one robot generates and sends control instructions that respectively enable one or more robots in the robot team to cooperatively complete the team task; otherwise, it receives and executes a control instruction from the leader robot. Determination of the leader robot can include evaluating a leadership competence of each cooperating robot in the team, and assigning the robot with the highest leadership competence as the leader robot. A device in a robot to enable it to cooperatively work with other robots in a robot team, a robot having the device, and a robot system having more than one robot can employ the method.

### CROSS-REFERENCE TO RELATED APPLICATION

The present application is a continuation of International Patent Application No.: PCT/CN2016/113249 filed on Dec. 29, 2016, the disclosure of which is incorporated by reference herein in its entirety.

### BACKGROUND

With the rapid development of mobile internet technologies, machine to machine (M2M) technologies, and internet of things (IoTs) technologies, the adoption of intelligent terminals in replacement of manual work to complete various complex operations has become increasingly popular, and robots are a typical type of intelligent terminals.

With the increasingly refined division of labor among robots, different robots are configured to specialize in processing different tasks respectively, and therefore, the cooperation among a plurality of robots has become more and more important.

### SUMMARY

The present disclosure relates to the technical field of robots, and particularly to a robot cooperation method and device, a robot, and a computer program product.

Embodiments of the present disclosure provide a robot cooperation method and device, a robot, a computer program product, and a robot system, mainly to improve the control flexibility for robot cooperation.

In a first aspect, the present disclosure provides a method for cooperating a plurality of robots in a robot network. The method comprises the following steps or operations:

acquiring information of a team task;

determining, based on the acquired information of the team task, each robot in a robot team in the robot network, the robot team comprising at least one cooperating robot;

determining a leader robot of the robot team; and

determining whether any one robot in the robot team is the leader robot; and

if so, in the any one robot: generating at least one control instruction configured respectively to enable one or more robots in the robot team to work cooperatively to complete the team task; and sending the at least one control instruction respectively to the one or more robots in the robot team;

or if otherwise, in the any one robot: determining the leader robot in the robot team; receiving a control instruction from the leader robot; and executing the control instruction.

According to some embodiments, the step of determining a leader robot of the robot team is based on leadership competence evaluation, and comprises the following sub-steps/sub-operations:

determining a leadership competence of each of the at least one cooperating robot in the robot team based on information of a state thereof and the information of the team task; and

assigning one of the at least one cooperating robot in the robot team with a highest leadership competence as the leader robot.

Herein optionally, the sub-step of determining a leadership competence of each of the at least one cooperating robot in the robot team comprises the following sub-steps:

determining, in any one of the at least one cooperating robot, a leadership competence thereof based on information of a state thereof and the information of the team task; and

sending, from the any one of the at least one cooperating robot to each other robot in the robot team, the leadership competence thereof.

Herein, the information of the state of a robot can comprise at least one parameter, which can be selected from a group consisting of a position, an attitude, movability, a type, a computing power, endurance, a communication capability, and a security state.

Optionally, the leadership competence of each of the at least one cooperating robot in the robot team can be quantitatively represented as a total score combining a score of each of the at least one parameter. Further optionally, the score of each of the at least one parameter can have a pre-determined weight specific to the team task for calculating the total score.

In the method, the sub-step of assigning one of the at least one cooperating robot in the robot team with a highest leadership competence as the leader robot can include the following sub-operations:

comparing a leadership competence of each of the at least one cooperating robot in the robot team; and

if there is only one cooperating robot having a highest leadership competence in the robot team, assigning the one of the at least one cooperating robot as the leader robot; or

if there are more than one cooperating robot having a same highest leadership competence in the robot team, assigning one of the more than one cooperating robot which first sends a leadership competence thereof to each other robot in the robot team as the leader robot.

According to some embodiments of the method, the step of determining, based on the acquired information of the team task, each robot in a robot team in the robot network comprises: determining, through an authentication process, that each of the at least one cooperating robot in the robot team is an authenticated robot. Herein, the authentication process can comprise an authentication over at least one of a security of communication connections with other robots in the robot team, a model number, software security, or hardware integrity.

The method can, after the determining whether any one robot in the robot team is the leader robot and before the generating at least one control instruction in the any one robot if determined that the any one robot is the leader robot, optionally further comprise: sending a message indicating that the any one robot is the leader robot to each other robot in the robot team.

According to some embodiments, the method can, after the determining a leader robot of the robot team, further comprises:

upon detecting that the leader robot is incapable of serving as a leader robot in the robot team, determining another one of the at least one cooperating robot in the robot team as a new leader robot.

In any one of the embodiments of the method as described above, the information of the team task can optionally be transmitted to each of the plurality of robots in the robot network in a broadcast manner, or can optionally be specifically transmitted to each of the plurality of robots in the robot network related to the team task.

In a second aspect, the present disclosure further provides a device in a robot enabling the robot to cooperatively work with other robot in a robot network. The device is substantially configured to implement the steps of the method as described above. The device includes a communication module, a task analysis module, a leader robot determining module, a role determining module, a control module, and an execution module.

The communication module is configured to acquire information of a team task.

The task analysis module is configured to determine, based on the acquired information of the team task, each robot in a robot team in the robot network. Herein the robot team comprises at least one cooperating robot.

The leader robot determining module is configured to determine a leader robot in the robot team.

The role determining module, which is configured to determining whether the robot is the leader robot.

The control module is configured, if the role determining module determines that the robot is the leader robot, to generate at least one control instruction configured respectively to enable one or more robots in the robot team to work cooperatively to complete the team task.

The execution module is configured, if the role determining module determines that the robot is not the leader robot, to execute a control instruction received from the leader robot in the robot team.

According to some embodiments of the device, the leader robot determining module is configured to determine a leader robot in the robot team by means of leadership competence evaluation. As such, the communication module is further configured to obtain information of a state of each of the at least one cooperating robot in the robot team, and the leader robot determining module comprises:

a leadership competence determining submodule, which is configured to determine a leadership competence of each of the at least one cooperating robot in the robot team based on the information of the state thereof and the information of the team task; and

an assigning submodule, which is configured to assign one of the at least one cooperating robot in the robot team with a highest leadership competence as the leader robot.

Optionally, in the embodiments of the device described above, the communication module can be further configured to send a leadership competence of the robot to each other robot in the robot team.

If the role determining module determines that the robot is the leader robot, the communication module can be further configured to acquire information of a state of each other robot in the robot team; the control module can be further configured to generate the at least one control instruction based on information of a state of the robot, the information of the state of each other robot, and the information of the team task; and the communication module can be further configured to send the at least one control instruction to the one or more robots in the robot team respectively. Further optionally, the communication module can be further configured to send a message indicating that the robot is the leader robot to each other robot in the robot team.

If the role determining module determines that the robot is not the leader robot, the communication module can be further configured to receive the control instruction from the leader robot.

In a third aspect, the present disclosure further provides a robot, which comprises a device according to any one of the embodiments as described above.

In a fourth aspect, a computer program product is further provided, which can be used in combination with the robot as described above. The computer program product can include a computer program embedded into a computer-readable storage medium, and the computer program comprises instructions configured to enable the robot to execute each of the steps in any of the above mentioned embodiments of the method.

In a fifth aspect, the present disclosure further provides a robot system, which comprises at least one robot, each according to any one of the embodiments of the robot as described above in the third aspect.

### BRIEF DESCRIPTION OF DRAWINGS

Specific embodiments of the present disclosure will be described below with reference to the drawings set forth in the following.

FIG. 1A is a flow chart of a robot cooperation method according to some embodiments of the present disclosure;

FIG. 1B is a flow chart of a robot cooperation method according to one specific embodiment of the present disclosure;

FIG. 2 is a structure diagram of a robot cooperation device according to one specific embodiment of the present disclosure;

FIG. 3 is a structure diagram of a robot according to some embodiments of the present disclosure.

### DETAILED DESCRIPTION

In order to make the technical solutions provided in the present disclosure and the advantages thereof clearer, exemplary embodiments will be described below in detail in combination with the drawings as set forth above. It is apparent that the described embodiments are not all, but only part, of embodiments of the present disclosure. Moreover, the embodiments in the disclosure and characteristics in the embodiments may be combined without conflicts.

In a conventional technology for realizing a cooperation of robots in a robot system, a controller (for example, a control platform) is usually utilized to transmit control instructions based on different cooperation tasks to a plurality of robots that are configured to work cooperatively, and the plurality of robots can respectively execute control instructions corresponding thereto to thereby realize a cooperation among them.

During the development of the invention disclosed herein, the inventor has observed the following shortcomings associated with the above conventional technologies. In a process in which multiple robots work cooperatively to complete a task, the controller is typically fixed and is therefore configured to universally transmit control instructions to the plurality of robots. Such a manner of controlling the cooperation typically has disadvantages such as heavy burdens and the inflexibility of control.

In order to address the above issues associated with the current technologies, on a first aspect, the present disclosure provides a robot cooperation method. Briefly, after a plurality of robots in a robot network receives information of a cooperation task (i.e. team task), a robot team assigned to execute the task can be determined, and independently a leader robot in the robot team can also be determined. The leader robot controls each robot in the robot team to cooperatively complete the task. In the present disclosure, the leader robot in the robot team independently controls the robot team to cooperatively complete the task, so that a control burden is light, and higher control flexibility is achieved.

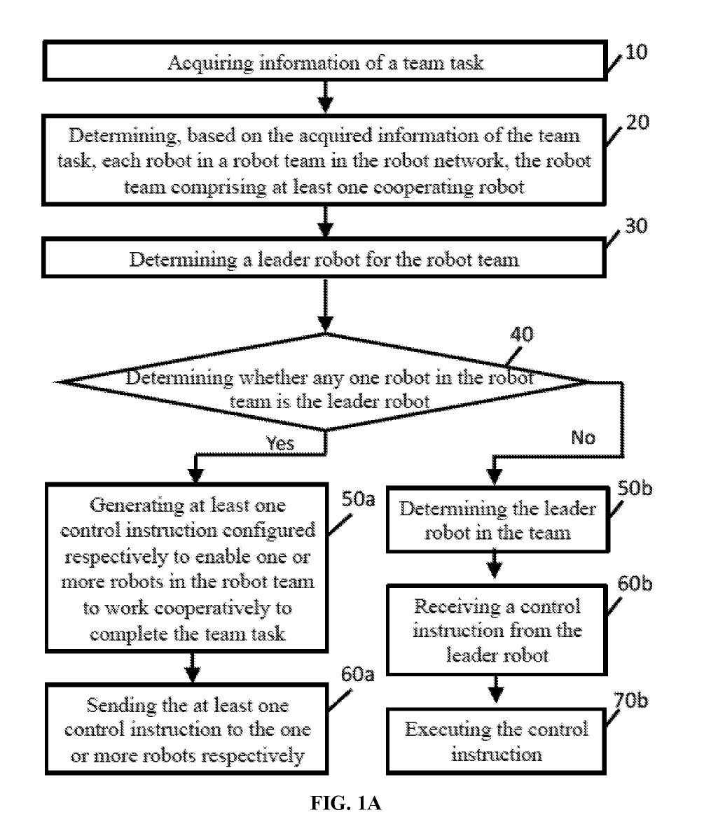

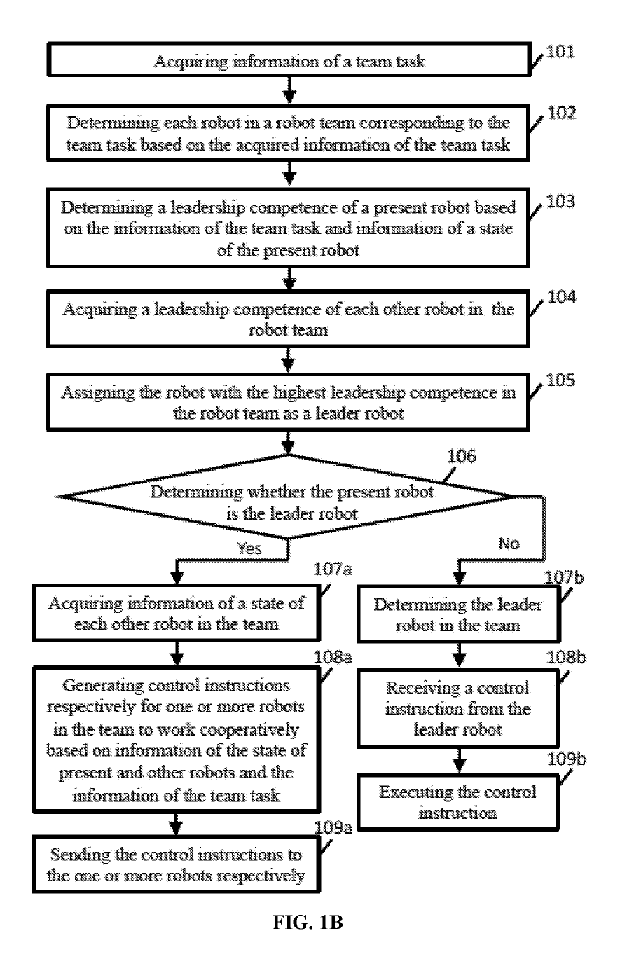

Specifically, the robot cooperation method is substantially a method for cooperating a plurality of robots in a robot network, which comprises the following steps or operations, as illustrated in FIG. 1A:

S10: acquiring information of a team task;

S20: determining, based on the acquired information of the team task, each robot in a robot team in the robot network, the robot team comprising at least one cooperating robot;

S30: determining a leader robot of the robot team; and

S40: determining whether any one robot in the robot team is the leader robot; and

If so, in the any one robot, the following steps/operations are performed:

S50a: generating at least one control instruction configured respectively to enable one or more robots in the robot team to work cooperatively to complete the team task; and

S60a: sending the at least one control instruction respectively to the one or more robots in the robot team.

If otherwise, in the any one robot, the following steps/operations are performed:

S50b: determining the leader robot in the robot team;

S60b: receiving a control instruction from the leader robot; and

S70b: executing the control instruction.

Herein, the step of determining a leader robot of the robot team can be based on leadership competence evaluation, or can be based on some other approaches.

In the following, one specific embodiment (i.e. Embodiment 1) of the robot cooperation method is provided, in order to give an illustrating example.

In the embodiment, various intelligent terminal devices are collectively referred to as robots. A plurality of robots form a network (i.e. robot network), are communicatively connected with one another, and are configured to communicate when necessary. A user may assign a robot team task (i.e. team task) to the robot network. Multiple robots in the robot network can form a team (i.e. robot team), and the robots in the robot team are configured to work cooperatively so as to complete the team task.

FIG. 1B is a flow chart of a robot cooperation method according to Embodiment 1 of the present disclosure. As shown in FIG. 1B, the robot cooperation method includes the following steps.

Step 101: acquiring information of a team task; Step 102: determining each robot in a robot team corresponding to the team task based on the acquired information of the team task;

Step 103: determining a leadership competence of a present robot based on the information of the team task and information of a state of the present robot;

Step 104: acquiring a leadership competence of each other robot in the robot team;

Step 105: assigning the robot with the highest leadership competence in the robot team as a leader robot;

Step 106: determining whether the present robot is the leader robot, and executing Steps 107a-109a if so, or executing Steps 107b-109b if otherwise;

Step 107a: if determining that the present robot is the leader robot, acquiring information of a state of each other robot in the robot team;

Step 108a: generating control instructions respectively for one or more robots in the robot team based on the information of the state of the present robot, the information of the state of the each other robot, and the information of the team task, wherein the control instructions are configured to respectively control the one or more robots in the robot team to work cooperatively so as to complete the team task;

Step 109a: sending the control instructions to the one or more robots in the robot team respectively;

Step 107b: if determining that the present robot is a non-leader robot, determining the leader robot in the robot team;

Step 108b: receiving a control instruction from the leader robot; Step 109b: executing the control instruction.

In Step 101, the information of the team task can be sent or transmitted to the robots from a robot control platform, a task platform, or a user, etc. Optionally, the information of the team task can be transmitted in a broadcast manner, and thus all robots in the robot network can receive the information of the team task. Optionally, the information of the team task can also be transmitted to a robot related thereto (i.e. related robot) in a specific manner (i.e. the information of the team task is only sent to robots in the robot network that are related to the information of the team task). For example, if the team task is to acquire images of a certain object to thereby build a model based on the images, the information of the team task is only sent to robots that are near the object and have an image acquisition functionality or a modeling functionality. Each related robot is configured to acquire the information of the team task according to each of the above different manners.

In Step 102, after a robot receives the information of the team task, the robot can determine each robot in a robot team corresponding to the team task based on the information of the team task.

The information of the team task can include information about each robot in the robot team. That is, the robots that form the robot team so as to execute the team task have been pre-determined when the team task is assigned. The information of the team task may optionally be sent to all of the robots in a broadcast manner, or may optionally be sent to each robot in a pre-determined team. A certain robot may find or identify the other robots in the robot team, which it belongs to, based on the information of the team task.

The process for determining each robot in the robot team in Step 102 can include the following: after obtaining the information of the team task, each robot can determine whether it belongs to the robot team configured to execute the team task, and if so (i.e. it belongs to the robot team), then other robots that also belong to the robot team can be figured out or found based on communications between robots to thereby further determine all robots in the robot team.

According to some embodiments, Step 102 further includes: determining that each robot in the robot team corresponding to the team task is an authenticated robot.

In other words, in Step 102, the robots that belong to the same robot team are all determined to be robots that pass the authentication. Herein, the authentication can be an authentication over the security of communication connections with the other robots in the robot team, or optionally can be an authentication over a model number, software security, or hardware integrity, etc. of the robot terminals. An authentication process can be implemented after that each robot in the robot team is determined. In other words, each robot in the robot team is first determined based on the information of the team task, who subsequently undergoes the authentication process to determine if it is an authenticated robot. Only robots that have passed the authentication process are kept in the team. Alternatively, an authentication process can also be implemented before that each robot in the team is determined. In other words, only authenticated robots are selected for the determination whether they belong to the robot team executing the team task.

In Step 103, each robot in the robot team may determine its own leadership competence in executing the team task based on the information of the team task that has been obtained and the information of the state of its own. In other words, each robot in the robot team can estimate its own leadership competence in executing the team task based on its own matching level with the team task, and its operational performance, etc.

According to some embodiments, the information of the state of a present robot includes any one, or a combination of several, of the following parameters regarding:

a position of the robot, which may include a longitude, a latitude, a height, and/or a distance with an execution point of the team task, etc. of the robot at a present moment;

an attitude of the robot, which may include an orientation, and/or an action pattern, etc. of the robot at the present moment;

movability of the robot, which may include whether the robot is movable or not, a moving manner, an average moving speed, and/or a maximum moving speed, etc. of the robot;

a type of the robot, which may include a model number, a function, a sensor mounted thereon, and/or an external device connected therewith, etc. of the robot;

a computing power of the robot, which may include a computing power of the central processing unit (CPU) in the robot;

endurance of the robot, which may include a remaining power, and/or a duration for which running may be maintained by the remaining power, etc. of the robot at the present moment;

a communication capability of the robot, which may include a manner of communication, a bandwidth of communication, and/or a quality of communication, etc. of the robot; and

a security state of the robot, which may include a security state of the robot at the present moment that is determined after a check-up of softwares and hardwares of the robot.

With regard to different team tasks, each of the above mentioned parameters of the robot can be evaluated, and then a quantitative grade/score of evaluation can be provided. For example, when a certain parameter meets a requirement on the leader robot, if the parameter has a higher value, it has a higher score. Scores of each parameter can finally be added to thereby obtain a total score of the leadership competence. If the total score for a robot is higher, it indicates that the robot is more suitable to serve as the leader robot in the robot team for the present task. In addition, for different tasks, the parameters may further be assigned with different weights, so as to more reasonably calculate the leadership competence of the robot.

According to some embodiments, after Step 103, the method further includes a step whereby the leadership competence of the present robot is sent to each other robot in the robot team. That is, after the leadership competence of the present robot is determined, the leadership competence of the present robot is notified to each other robot in the robot team. Specifically, the leadership competence of the present robot can optionally be directly sent through a direct communication with each other robot. Optionally, the leadership competence of the present robot can also be first collected by a platform server, which can then forward the leadership competence of the present robot to each other robot.

In Step 104, the leadership competence of each other robot in the robot team is acquired. The leadership competence may be a competence evaluation grade, an evaluation score or alike. The leadership competence may be received by the present robot via direct communications among robots, or may be collected and forwarded to the present robot by a platform server. There is no limitation to the sequence of Step 103 and Step 104.

In Step 105, after the leadership competence of all the robots in the robot team is acquired, the robot with the highest leadership competence can be determined or assigned as the leader robot. That is, the leader robot is determined according to the leadership competence evaluation grades, or the leadership competence evaluation scores, etc. of the robots.

According to some embodiments, when the leader robot does not work normally, another robot with a highest leadership competence in the robot team can then be determined again as the leader robot.

During the subsequent task execution process, when the leader robot that has been determined or assigned does not work normally as the leader robot (e.g., when a software security risk of the leader robot is higher than a certain threshold value, when a hardware failure occurs, when the communicating connections are lost, or when the computing load exceeds a certain threshold value, etc.), the leader robot can actively notify each robot to determine or assign another leader robot, or each robot in the robot team can voluntarily determine another leader robot after the loss of communication with the leader robot previously determined or assigned.

It is noted that the above Steps 103-105 only provide one manner for determining the leader robot, i.e. based on the leadership competence evaluation. Other manners can optionally be adopted as well. For example, the leader robot can be explicitly indicated in the information of the team task that has been obtained; or the first robot receiving the information of the team task can be assigned or determined as the leader robot; the leader robot is determined through a negotiation between the robots in the robot team.

In Step 106, any one of the robots in the robot team determines whether it is a leader robot or not. If a certain robot determines that it is the leader robot, Steps 107a-109a can be executed.

In Step 107a, when and if a certain robot determines that it is the leader robot in the robot team executing the team task, information of a state of each other robot in the robot team is acquired or obtained, and herein the information of the state of each other robot can also include any one, or a combination of several, of the parameters mentioned above in Step 103 (i.e. position, altitude, movability, etc. of each other robot).

According to some embodiments, Step 107a can further include: sending a message indicating that the present robot is the leader robot to each other robot in the robot team.

That is, when a certain robot determines that it is the leader robot based on, for example, the leadership competences of all the robots in the robot team as set forth above in Steps 103-105, or based on another manner, a message (e.g. information of the identity or identify information) indicating that the present robot is the leader robot can be sent to each other robot in the robot team as soon as possible. In cases where the manner of determining the leader robot is based on the leadership competences, if a leadership competence of the present robot and a leadership competence of at least one another robot in the robot team are the same, a pre-determined rule (e.g. the one robot sending the identity information first is the leader robot in the robot team) can be further applied for the determination of which one of the robots is the leader robot.

In Step 107a, each robot which is a non-leader robot can send the information of the state of its own to the leader robot after the leader robot has been determined based on the leadership competences, or alternatively can send the information of the state of its own after receiving the message (i.e. identity information) from the leader robot.

In Step 108a, the leader robot generates control instructions configured to allow the robots in the robot team to work cooperatively to complete the team task based on the information of the team task and the information of the state of all the robots in the robot team. Herein, the control instructions to be received by the robots in the team can include, for example, instructions controlling operations of a robot regarding movement, image acquisition, carrying, and transformation, etc.

For a relatively intelligent robot, the control instruction can be a relatively complex instruction such as an instruction indicating a modeling robot in the team to perform a three-dimensional modeling on a certain object. The modeling robot, after receiving the above mentioned instruction, can independently determine a series of work contents thereof, which include, for example, positioning the object, moving to the vicinity of the object, circularly moving around the object, acquiring images of the object at multiple fixed angles, and performing image processing to obtain a three-dimensional model of the object, etc.

Each control instruction transmitted to each robot by the leader robot can also be an instruction set. The instruction set can include multiple sub-control instructions, and an execution time can be set for each of the multiple sub-control instructions to thereby enable each robot to work cooperatively on the basis of different instruction execution time. For example, the leader robot may transmit a control instruction to a carrying robot in the robot team to enable it, after the above mentioned modeling robot completes the modeling, to carry the object according to three-dimensional modeling information of the object.

It can be understood that, after the information of the state of each robot in the team is comprehensively considered, only one robot may be implicated to complete the team task, or alternatively, multiple robots, or even all robots, may be implicated to complete the team task. The team task may be completed by the leader robot, or the team task may be completed by a non-leader robot. The team task may also be completed by the leader robot and one or more non-leader robots.

In Step 109a, the control instructions corresponding to the one or more robots in the robot team are sent to the robots respectively to enable the one or more robots in the team to execute their respective control instruction to work cooperatively to thereby complete the team task.

If a certain robot determines that it is a non-leader robot in Step 106, Steps 107b-109b are executed.

In Step 107b, if one robot determines that it is not the leader robot in the corresponding robot team, it can determine the leader robot based on the leadership competence of each robot through Steps 103-105 as described above, or can determine the leader robot after receiving the identity information sent by the leader robot.

After determining the leader robot, the information of the state of the one robot can be sent to the leader robot to enable the leader robot to transmit the control instructions for the cooperative completion of the team task based on a comprehensive consideration of the information of the state of each robot in the robot team.

In Step 108b, each non-leader robot receives the control instruction sent by the leader robot.

In Step 109b, each non-leader robot executes the control instruction sent by the leader robot to thereby realize a cooperation among the robots in the team to complete the team task.

In the present disclosure, a robot, after receiving information of a cooperation task, can determine the robot team executing the cooperation task, and can further independently determine a leader robot in the robot team. The leader robot controls each robot in the robot team to work cooperatively to complete the cooperation task.

In the present disclosure, the leader robot in the robot team independently controls the robot team to cooperatively complete the task, so that a control burden is light, and a higher control flexibility can be achieved.

According to certain embodiments of the present disclosure as illustrated in FIG. 1A or FIG. 1B, a leadership competence can be calculated based on the information of the state of each robot in the robot team, and the leader robot may be determined in a more reasonable manner if such a determination is based on the calculation of the leadership competences. When or if the leader robot that have been determined is not able to serve as the leader robot (e.g. it does not work or run normally), another leader robot can be determined or assigned to thereby ensure normal cooperation of the robot team at any time. All of the robots in the team can be authenticated robots, so that the security of the robot team can be improved. In addition, the present disclosure further provides a solution of transmitting various types of information between each robot in the robot team, which can ensure a reliable implementation of the cooperation process.

On a second aspect, the embodiment of the present disclosure further provides a device in a robot enabling the robot to cooperatively work with other robot in a robot network (i.e. robot cooperation device). The working principle of the device is similar to that of the robot cooperation method as described above, and thus implementation of the device may reference to the implementation of the aforementioned method, and certain repeated parts may not be elaborated herein.

The device includes the following functional modules, which are substantially configured to implement the steps of the method as described above. The functional modules include:

a communication module, which is configured to acquire information of a team task;

a task analysis module, which is configured to determine, based on the acquired information of the team task, each robot in a robot team in the robot network, wherein the robot team comprises at least one cooperating robot;

a leader robot determining module, which is configured to determine a leader robot in the robot team;

a role determining module, which is configured to determining whether the robot is the leader robot; and

a control module, which is configured, if the role determining module determines that the robot is the leader robot, to generate at least one control instruction configured respectively to enable one or more robots in the robot team to work cooperatively to complete the team task; and

an execution module, which is configured, if the role determining module determines that the robot is not the leader robot, to execute a control instruction received from the leader robot in the robot team.

According to some embodiments of the robot cooperation device, the leader robot determining module is configured to determine a leader robot in the robot team by means of leadership competence evaluation. As such, the communication module is further configured to obtain information of a state of each of the at least one cooperating robot in the robot team, and the leader robot determining module comprises:

a leadership competence determining submodule, which is configured to determine a leadership competence of each of the at least one cooperating robot in the robot team based on the information of the state thereof and the information of the team task; and

an assigning submodule, which is configured to assign one of the at least one cooperating robot in the robot team with a highest leadership competence as the leader robot.

In the following, one specific embodiment (i.e. Embodiment 2) of the robot cooperation device is provided.

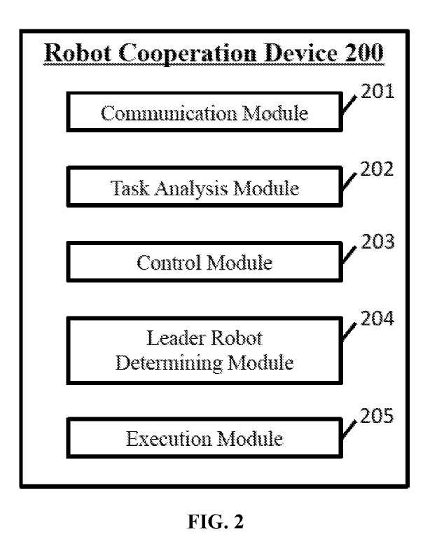

As shown in FIG. 2, the robot cooperation device 200 includes a communication module 201, a task analysis module 202 and a control module 203.

The communication module 201 is configured to acquire the information of the team task. The task analysis module 202 is configured to determine each robot in a robot team corresponding to a team task based on the information of the team task. The communication module 201 is further configured, upon determining that the present robot is the leader robot, to acquire information of a state of each other robot in the robot team.

The control module 203 is configured to generate control instructions for one or more robots in the robot team based on the information of the state of the present robot, on the information of the state of each other robot, and on the information of the team task. The control instructions are configured to respectively control the robots in the robot team to work cooperatively to complete the team task. Optionally, the communication module 201 is further configured to send the control instructions to the one or more robots in the robot team respectively.

According to some embodiments, before the communication module 201 acquires the information of the state of each other robot in the robot team, the communication module 201 is further configured to acquire a leadership competence of each other robot in the robot team.

The device 200 further includes a leader robot determining module 204, which is configured to determine a leadership competence of the present robot according to the information of the team task and the information of the state of the present robot, and is further configured to determine or assign the robot with the highest leadership competence in the robot team as the leader robot.

According to some embodiments, the communication module 201 is further configured, after the leader robot determining module 204 determines the leadership competence of the present robot based on the information of the team task and the information of the state of the present robot, to send the leadership competence of the present robot to each other robot in the robot team.

According to some embodiments, the leader robot determining module 204 is further configured, after determining the robot with the highest leadership competence in the robot team as the leader robot, if the leader robot does not run normally, to determine another robot with the highest leadership competence in the robot team as the leader robot.

According to some embodiments, the communication module 201 is further configured, if determining that the present robot is the leader robot, to send a message indicating that the present robot is the leader robot to each other robot in the robot team.

According to some embodiments, the leader robot determining module 204 is further configured, if determining that the present robot is a non-leader robot, to determine the leader robot in the robot team.

The communication module 201 is further configured to receive a control instruction sent by the leader robot.

The device 200 further includes an execution module 205, which is configured to execute the control instruction.

According to some embodiments, the task analysis module 202 is specifically configured to determine each authenticated robot in the robot team corresponding to the team task based on the information of the team task.

According to some embodiments, the information of the state includes any one, or a combination of several, of the following parameters: a position, an attitude, movability, a type, a computing power, endurance, a communication capability, and a security state.

On a third aspect, the embodiment of the present disclosure also provides a robot. The robot can comprise a robot cooperation device according to any one of the embodiments as described above.

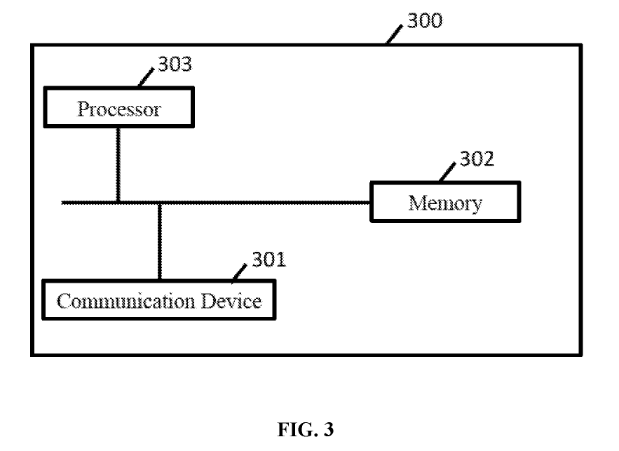

FIG. 3 shows a robot according to one specific embodiment (i.e. Embodiment 3) of the disclosure. As shown, the robot 300 includes a communication device 301, a memory 302, one or more processors 303, and one or more modules. The one or more modules are stored in the memory and configured to be executed by the one or more processors. The one or more modules comprise instructions configured to execute each of the steps in any of the above mentioned embodiments of the method.

Herein, various intelligent terminal devices are collectively referred to as robots.

On the same inventive concept, the present disclosure further provides a computer program product that can be used in combination with a robot as described above. The computer program product includes a computer program embedded into a computer-readable storage medium, and the computer program comprises an instruction configured to enable the robot to execute each of the steps in any of the above mentioned embodiments of the method.

For convenient description, each part of the device is functionally divided into various modules for respective description. It is noted that, when the present disclosure is implemented, the function of each module or unit may be implemented in one or more pieces of software or hardware.

Those skilled in the art should know that the embodiment of the present disclosure may be provided as a method, a system or a computer program product. Therefore, the present disclosure may adopt a form of pure hardware embodiment, pure software embodiment or combined software and hardware embodiment. Moreover, the present disclosure may adopt a form of computer program product implemented on one or more computer-available storage media (including, but not limited to, a disk memory, a Compact Disc Read-Only Memory (CD-ROM) and an optical memory) including computer-available program codes.

The present disclosure is described with reference to flow charts and/or block diagrams of the method, device (system) and computer program product according to the embodiments of the present disclosure. It is to be understood that each flow and/or block in the flow charts and/or the block diagrams and combinations of the flows and/or blocks in the flow charts and/or the block diagrams may be implemented by computer program instructions. These computer program instructions may be provided for a universal computer, a dedicated computer, an embedded processor or a processor of another programmable data processing device to generate a machine, so that a device for realizing a function specified in one flow or multiple flows in the flow charts and/or one block or multiple blocks in the block diagrams is generated by the instructions executed through the computer or the processor of the other programmable data processing device.

These computer program instructions may also be stored in a computer-readable memory capable of guiding the computer or the other programmable data processing device to work in a specific manner, so that a product including an instruction device may be generated by the instructions stored in the computer-readable memory, the instruction device realizing the function specified in one flow or multiple flows in the flow charts and/or one block or multiple blocks in the block diagrams.

These computer program instructions may further be loaded onto the computer or the other programmable data processing device, so that a series of operating steps are executed on the computer or the other programmable data processing device to generate processing implemented by the computer, and steps for realizing the function specified in one flow or multiple flows in the flow charts and/or one block or multiple blocks in the block diagrams are provided by the instructions executed on the computer or the other programmable data processing device.

On another aspect of the disclosure, a robot system is further provided, which can include a plurality of robots that are communicatively connected with one another. In the robot system, each of the robots can be equipped with a robot cooperation device according to any one of the embodiments as described above, and thus the robot cooperation method can be implemented to the robot system.

When a team task is assigned to the robot system, any robot, after receiving the team task, can determine each member of a robot team that cooperatively work to execute the team task, and can further independently determine a leader robot in the robot team by evaluating, for example, a leadership competence of each cooperating robot in the team. Then for any one cooperating robot in the team, at first its role needs to be determined. If the role of one particular robot is determined as the leader robot, it can generate and send control instructions to each cooperating robot in the team. If the role is determined as a non-leader robot, it can receive a control instruction from the leader robot and then execute a task correspond to the control instruction. Therefore, in the present disclosure, the leader robot in the robot team independently controls the robot team to cooperatively complete the task, so that the control burden is light, and a higher control flexibility can be realized.

Although the preferred embodiments of the present disclosure have been described, those skilled in the art, once learning about basic creative concepts, may make other variations and modifications to these embodiments. Therefore, it is intended to explain the appended claims to include the preferred embodiments and all the variations and modifications falling within the scope of the present disclosure.

1. A method for cooperating a plurality of robots in a robot network, comprising:
acquiring information of a team task;
determining, based on the acquired information of the team task, each robot in a robot team in the robot network, the robot team comprising at least one cooperating robot;
determining a leader robot of the robot team; and
determining whether any one robot in the robot team is the leader robot, and
if so, in the any one robot:
generating at least one control instruction configured respectively to enable one or more robots in the robot team to work cooperatively to complete the team task; and
sending the at least one control instruction respectively to the one or more robots in the robot team;
or if otherwise, in the any one robot:
determining the leader robot in the robot team;
receiving a control instruction from the leader robot; and
executing the control instruction.

2. The method of claim 1, wherein the determining a leader robot of the robot team is based on leadership competence evaluation, and comprises:
determining a leadership competence of each of the at least one cooperating robot in the robot team based on information of a state thereof and the information of the team task;
assigning one of the at least one cooperating robot in the robot team with a highest leadership competence as the leader robot.

3. The method of claim 2, wherein the determining a leadership competence of each of the at least one cooperating robot in the robot team comprises:
determining, in any one of the at least one cooperating robot, a leadership competence thereof based on information of a state thereof and the information of the team task; and
sending, from the any one of the at least one cooperating robot to each other robot in the robot team, the leadership competence thereof.

4. The method of claim 2, wherein the information of the state comprises at least one parameter selected from a group consisting of a position, an attitude, movability, a type, a computing power, endurance, a communication capability, and a security state.

5. The method of claim 4, wherein the leadership competence of each of the at least one cooperating robot in the robot team is quantitatively represented as a total score combining a score of each of the at least one parameter.

6. The method of claim 5, wherein the score of each of the at least one parameter has a pre-determined weight specific to the team task for calculating the total score.

7. The method of claim 2, wherein the assigning one of the at least one cooperating robot in the robot team with a highest leadership competence as the leader robot comprises:
comparing a leadership competence of each of the at least one cooperating robot in the robot team; and
if there is only one cooperating robot having a highest leadership competence in the robot team, assigning the one of the at least one cooperating robot as the leader robot; or
if there are more than one cooperating robot having a same highest leadership competence in the robot team, assigning one of the more than one cooperating robot which first sends a leadership competence thereof to each other robot in the robot team as the leader robot.

8. The method of claim 1, wherein the determining, based on the acquired information of the team task, each robot in a robot team in the robot network comprises:
determining, through an authentication process, that each of the at least one cooperating robot in the robot team is an authenticated robot.

9. The method of claim 8, wherein the authentication process comprises an authentication over at least one of a security of communication connections with other robots in the robot team, a model number, software security, or hardware integrity.

10. The method of claim 1, further comprising, after the determining whether any one robot in the robot team is the leader robot and before the generating at least one control instruction in the any one robot if so:
sending a message indicating that the any one robot is the leader robot to each other robot in the robot team.

11. The method of claim 1, further comprising, after the determining a leader robot of the robot team:
upon detecting that the leader robot is incapable of serving as a leader robot in the robot team, determining another one of the at least one cooperating robot in the robot team as a new leader robot.

12. The method of claim 1, wherein the information of the team task is transmitted to each of the plurality of robots in the robot network in a broadcast manner.

13. The method of claim 1, wherein the information of the team task is specifically transmitted to each of the plurality of robots in the robot network related to the team task.

14. A device in a robot enabling the robot to cooperatively work with other robot in a robot network, comprising:
a communication module, configured to acquire information of a team task;
a task analysis module, configured to determine, based on the acquired information of the team task, each robot in a robot team in the robot network, wherein the robot team comprises at least one cooperating robot;
a leader robot determining module, configured to determine a leader robot in the robot team;
a role determining module, configured to determining whether the robot is the leader robot;
a control module configured, if the role determining module determines that the robot is the leader robot, to generate at least one control instruction configured respectively to enable one or more robots in the robot team to work cooperatively to complete the team task; and
an execution module configured, if the role determining module determines that the robot is not the leader robot, to execute a control instruction received from the leader robot in the robot team.

15. The device of claim 14, wherein the leader robot determining module is configured to determine a leader robot in the robot team by means of leadership competence evaluation, wherein:
the communication module is further configured to obtain information of a state of each of the at least one cooperating robot in the robot team;
the leader robot determining module comprises:
a leadership competence determining submodule, configured to determine a leadership competence of each of the at least one cooperating robot in the robot team based on the information of the state thereof and the information of the team task; and
an assigning submodule, configured to assign one of the at least one cooperating robot in the robot team with a highest leadership competence as the leader robot.

16. The device of claim 15, wherein the communication module is further configured to send a leadership competence of the robot to each other robot in the robot team.

17. The device of claim 14, wherein, if the role determining module determines that the robot is the leader robot:
the communication module is further configured to acquire information of a state of each other robot in the robot team;
the control module is further configured to generate the at least one control instruction based on information of a state of the robot, the information of the state of each other robot, and the information of the team task; and
the communication module is further configured to send the at least one control instruction to the one or more robots in the robot team respectively.

18. The device of claim 17, wherein the communication module is further configured to send a message indicating that the robot is the leader robot to each other robot in the robot team.

19. The device of claim 14, wherein, if the role determining module determines that the robot is not the leader robot:
the communication module is further configured to receive the control instruction from the leader robot.

20. A robot, comprising a device according to claim 14.
